(19) United States
(12) Patent Application Publication
(10) Pub. No.: US 2024/0365732 A1
(43) Pub. Date: Nov. 7, 2024

(54) System and Methods for Making Nutrient Composition

(71) Applicant: Waveseer, LLC, Chicago, IL (US)

(72) Inventor: Robert Singer, North Palm Beach, FL (US)

(73) Assignee: Waveseer, LLC, Chicago, IL (US)

(21) Appl. No.: 18/689,985

(22) PCT Filed: Sep. 7, 2022
(86) PCT No.: PCT/US22/42685

§ 371 Date: Mar. 7, 2024

Related U.S. Application Data
(60) Provisional application No. 63/241,580, filed on Sep. 8, 2021.

(51) Int. Cl. A01G 31/02; A01G 22/00; B01F 23/237; B01F 23/2375; B01F 23/50

(52) U.S. Cl. CPC A01G 31/02; A01G 22/00; B01F 23/2375; B01F 23/237612; B01F 23/237613; B01F 23/55; B01F 23/59

(57) ABSTRACT

A nutrient system includes at least one nutrient feed line for introducing at least one nutrient into a water inlet or supply to form a circulation stream: an eductor injector for introducing a powder comprising at least one dry nutrient into the circulation stream; an ultrasonic cavitation reactor for applying at least one frequency to the circulation stream; and a nanobubble generator module for introducing nanobubbles of at least one gas into the circulation stream. The system may also include a cooling/ultraviolet disinfection module for cooling and disinfecting the circulation stream. The system may be used to obtain a nutrient composition for a plant growing environment.

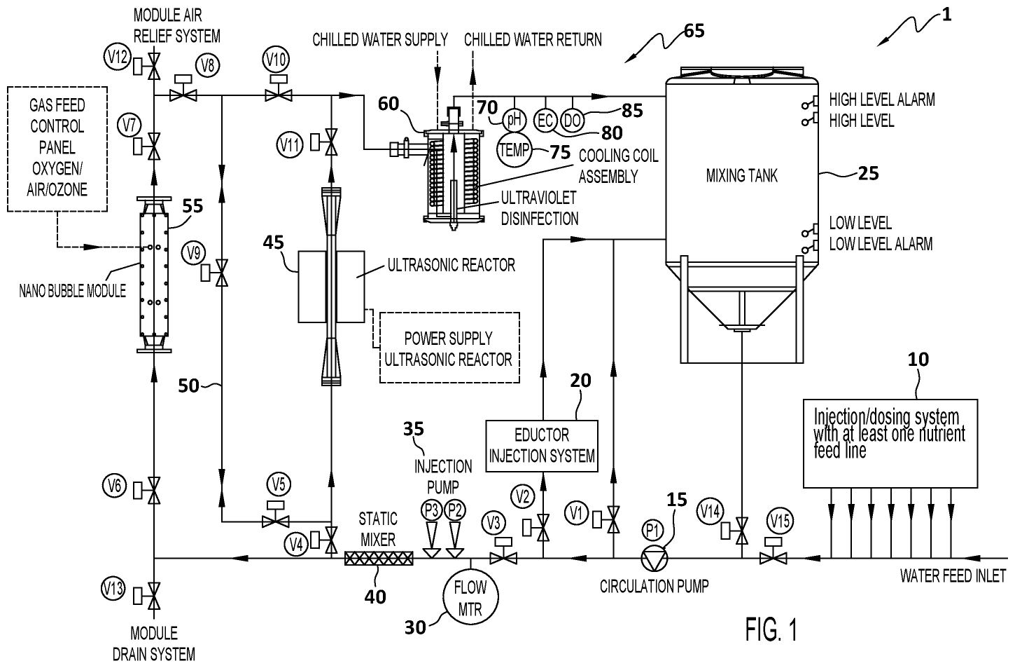

This PCT international application claims priority to U.S. Ser. No. 63/241,580 filed on 8 Sep. 2021 in the U.S. Patent and Trademark Office, the entirety of which is incorporated herein by reference.

### FIELD OF INVENTION

The present invention is directed to systems and methods for making a nutrient composition. In particular, the system and methods are directed to making a nutrient composition to be used in a growing environment, such as for growing fruits, vegetables, hemp, or cannabis.

### SUMMARY OF INVENTION

The invention provides a nutrient system including at least one nutrient feed line for introducing at least one nutrient into a water inlet or supply to form a circulation stream; an eductor injector for introducing a powder comprising at least one dry nutrient into the circulation stream; an ultrasonic acoustic cavitation reactor for applying at least one frequency to the circulation stream; and a nanobubble generator module for introducing nanobubbles of at least one gas into the circulation stream.

The invention provides in at least one system embodiment further to any of the previous embodiments a nutrient system including an ultrasonic acoustic cavitation reactor that is a dual frequency ultrasonic cavitation reactor.

The invention provides in at least one system embodiment further to any of the previous embodiments a nutrient system including a cooling/ultraviolet disinfection module for cooling and disinfecting the circulation stream.

The invention provides in at least one system embodiment further to any of the previous embodiments a nutrient system including at least one of at least one of a pH sensor to measure a pH of the circulation stream; at least one temperature sensor to measure a temperature of the circulation stream; at least one electroconductivity sensor to measure a nutrient level of the circulation stream; or at least one dissolved oxygen sensor to measure dissolved oxygen in the circulation stream.

The invention provides a method for obtaining a nutrient composition including introducing at least one nutrient into a water supply or inlet to form a circulation stream, wherein the at least one nutrient is in liquid or concentrate form; introducing a powder comprising at least one dry nutrient into the circulation stream by an eductor injector; and applying at least one frequency to the circulation stream by an ultrasonic acoustic cavitation reactor, thereby reducing a size of one or more nutrients in the circulation stream; and introducing nanobubbles of at least one gas into the circulation stream by a nanobubble generator module.

The invention provides in at least one method embodiment further to any of the previous embodiments a method including cooling and disinfecting the circulation stream and obtaining a nutrient composition or nutrient water.

The invention provides in at least one method embodiment further to any of the previous embodiments a method including introducing nanobubbles of one or more of oxygen, nitrogen, or ozone into the circulation stream.

The invention provides in at least one method embodiment further to any of the previous embodiments a method including applying dual frequencies to the circulation stream after introducing nanobubbles of at least one gas into the circulation stream.

The invention provides in at least one method embodiment further to any of the previous embodiments a method including adjusting at least one of a pH, nutrient level, temperature, or oxygen level of the circulation stream.

The invention provides in at least one method embodiment a method for growing a plant including feeding a nutrient composition or nutrient water obtained according to any of the previous embodiments to a growing environment. The growing environment may be a hydroponic environment comprising one or more plants. The one or more plants may be a fruit or vegetable. The one or more plants may be cannabis.

The invention provides in at least one method embodiment a method for customizing a nutrient composition or nutrient water for one or more plants to be grown in a growing environment including evaluating one or more plants that are fed the nutrient composition or nutrient water obtained according to any one of the previous embodiments; and adjusting at least one of a pH, nutrient level, temperature, oxygen level, or amount of water of the nutrient composition or nutrient water based on the evaluating.

The invention provides in at least one method embodiment further to any of the previous embodiments a method including evaluating one or more plants comprises analysis of at least one of a development stage of the one or more plants; a time of a water feeding cycle; a moisture level of the one or more plants; at least one nutrient level; or a temperature of the nutrient composition or nutrient water.

The invention provides in at least one method embodiment further to any of the previous embodiments a method including analysis of a growth history of one or more plants. The analysis may include a historical level of a particular plant chemical of the one or more plants. The one or more plants may be cannabis and the plant chemical may be at least one of at least one terpene; cannabidiol; cannabinol; cannabichromene; or tetrahydrocannabinol.

The invention provides in at least one method embodiment a method for growing a plant including customizing a nutrient composition or nutrient water obtained by any of the previous embodiments; feeding the nutrient composition or nutrient water to one or more plants in a plant growing environment; and increasing a plant yield or a level of plant chemical of the one or more plants.

An advantage of the system and methods of the present invention is that a nutrient composition or nutrient water may be made in which the amount of nutrient(s) needed for a plant is significantly reduced as compared to a conventional commercial nutrient compositions. By purchasing raw nutrient materials and preparing a nutrient composition using the system and methods of the present invention, the cost for obtaining a nutrient composition is substantially less than the cost of off-the-shelf nutrient compositions.

Another advantage of the system and methods of the present invention is that water use may be reduced as nutrient runoff may be recycled and reused.

Yet another advantage of the system and methods of the present invention is that a nutrient composition may be customized for the kind of plants to be grown.

### BRIEF DESCRIPTION OF THE DRAWING

The sole FIGURE is a schematic diagram of a system according to an embodiment of the present invention.

### DETAILED DESCRIPTION OF INVENTION

In this detailed description, references to “one embodiment”, “an embodiment”, “specific embodiment”, or “in embodiments” mean that the feature being referred to is included in at least one embodiment of the invention. Moreover, separate references to “one embodiment”, “an embodiment”, “specific embodiment”, or “embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

As used herein “substantially”, “generally”, “about”, and other words of degree are relative modifiers intended to indicate permissible variation from the characteristic so modified (e.g., +0.1%, +0.5%, +1.0%, +2%, +5%, +10%, +20%). It is not intended to be limited to the absolute value or characteristic which it modifies but rather possessing more of the physical or functional characteristic than its opposite, and preferably, approaching or approximating such a physical or functional characteristic.

The present invention is directed to systems and methods for making a nutrient composition or nutrient water to be used for growing plants. The systems and methods are not limited to any particular growing environment and may include, but are not limited to, a hydroponic environment or a soil environment (e.g., direct spot injection). In an embodiment, the systems and methods are directed to the preparing a nutrient composition to be used in a greenhouse or hydroponic system, such as growing fruits or vegetables (e.g., soybeans, tomatoes, strawberries, beets, onions, and the like). In a specific embodiment, the systems and methods are directed to preparing a nutrient composition or nutrient water to be used for growing hemp or cannabis in a desired environment.

As shown in the FIGURE, a system 1 for making a nutrient composition comprises an injection/dosing system with at least one nutrient feed line 10 for adding at least one nutrient to a water supply or inlet 12 to create a circulation stream comprising water and nutrient(s). The at least one nutrient added from at least one nutrient feed line may comprise a liquid or concentrate.

A dosing rate of the at least one nutrient may be controlled according to the specific needs of a desired nutrient composition or nutrient water. In specific embodiments, it is possible to not utilize the at least one nutrient feed line and to add at least one nutrient in the form of a powder as discussed below.

The system 1 includes a circulation pump 15 with variable speed to control velocity and pressure drops of the circulation stream within the system.

According to the present invention, the system 1 includes an eductor injector 20. In specific embodiments, the eductor injector 20 introduces a powder or power mixture of at least one dry nutrient into the circulation stream, which is then sent or returned to holding tank 25. The eductor injection 20 may be used alone or in combination with the at least one nutrient feed line 10 to add one or more nutrients to the circulation stream.

In an embodiment, the at least one nutrient added to the circulation stream from the at least one nutrient feed line 10 and/or from the eductor injector 20 may comprise at least one of chemicals, microbes, vitamins, or fertilizer used to grow plants. In a specific embodiment, the at least one nutrient may comprise, but is not limited to, one or more of potassium nitrate, manganese nitrate, calcium nitrate; sulfates of copper, manganese, or zinc; monoammonium phosphate; monopotassium phosphate; a boron compound; or a molybdenum compound. The resulting nutrient composition or nutrient water may comprise one or more of nitrogen, phosphorous, potassium, sulfur, molybdenum, calcium, magnesium, zinc, iron, manganese, copper, boron, or any combination thereof.

The system may include a flow meter 30 to measure or control pump speeds to achieve a desired flow rate for the circulation stream. One or more liquid pH injection pumps 35 may be used to control the pH of the circulation stream, either by increasing pH or lowering pH. The system may include a static mixer 40 to mix the circulation stream.

According to the present invention, the system 1 includes an ultrasonic acoustic cavitation reactor 45 to introduce at least one frequency acoustic cavitation to the circulation stream. In a specific embodiment, the ultrasonic acoustic cavitation reactor 45 introduces dual frequency acoustic cavitation to the circulation stream. In a specific embodiment, the dual frequencies may be about 17 kHz and about 20 KHz. The ultrasonic acoustic cavitation reactor may reduce the size of any undissolved or partially-dissolved nutrients in the circulation stream, for example, to nano-sized particles. The ultrasonic acoustic cavitation reactor may also reduce the size of dissolved nutrients in the circulation stream, for example, to nano-sized particles. The resulting nano-sized nutrients allow for optimum root uptake by plants and allows a quantity of nutrients in the nutrient composition or nutrient water to be significantly reduced.

The system 1 may include a bypass pipe 50 for controlling the order and use of ultrasonic acoustic cavitation reactor 45, for example, to be before or after a nanobubble generator module 55, as discussed below. Alternatively, the bypass pipe 50 may allow use of the ultrasonic acoustic cavitation reactor 45 without the nanobubble generator module 55.

The system includes a nanobubble generator module 55. The nanobubble generator module 55 introduces at least one gas (e.g., oxygen, ozone, nitrogen, ambient air) into the circulation stream as nanobubbles. The nanobubbles have a positive charge and stay suspended in the circulation stream. In a specific embodiment, the nanobubbles may have a bubble diameter of about 1 nm to about 10,000 nm, for example, 10 nm to 1,000 nm. In a specific embodiment, the system may be operated using only ozone from the nanobubble generator module to clean and disinfect the system without using any cleaning chemicals.

The nanobubbles may have several effects. First, the nanobubbles provide a large surface area per volume, so that when the circulation stream is subjected to ultraviolet light, disinfection of the water is increased due to a prism/UV light-scattering effect. Second, the nanobubbles in the nutrient composition or nutrient water attach to the roots of plants in a growing environment, thereby increasing the uptake of nutrients and reducing nutrient waste. Third, the nanobubbles may increase the size and/or mass of plants fed with the nutrient composition or nutrient water.

According to the present invention, the system 1 includes a cooling/ultraviolet disinfection module 60 comprising a housing; a heat exchanger comprising a helical coil or plurality of coils; and at least one UV light. The helical coil or plurality of coils are fed with chilled water or another chilled liquid. The at least on UV light may be housed in a quartz chamber or tube. The UV light may have a wavelength or 100-400 nm, for example about 150-300 nm, or about 185 nm, which may produce ozone from oxygen nanobubbles if in the circulation stream.

The circulation stream is fed to the water cooling/UV disinfection module 60. The circulation stream flows around the helical coil or plurality of cooling coils until the cooled circulation stream reaches a bottom of the module 60. The cooled circulation stream turns (e.g., 90-180 degrees) and travels up and out of a top of the cooling/disinfection module. The circulation stream moves upwards through a central internal passageway/cylinder that, in specific embodiments, may have an electropolished surface (e.g., a metal surface, stainless steel, or the like) or a mirrored surface. At least one internal UV bulb is located at or near the bottom of the module and exposes the circulation stream to UV light, which is scattered in near infinite directions for optimum disinfection of the circulation stream. This UV light scattering is due to the prism effect of the nanobubbles and their large surface area. In embodiments in which part or all of the nanobubbles comprise oxygen, the UV light may also create ozone, which helps with disinfection of the nutrient composition.

The system 1 includes a sensor network 65 for monitoring and controlling several parameters in the system. The sensor network may include one or more of:
A. at least one pH sensor 70. The pH sensor reads the pH of the circulation stream sent or returning to the holding tank and adjusts the pH injection pumps 35 to achieve the desired pH number.
B. at least one temperature sensor 75. The temperature sensor reads the temperature of the circulation stream and, based on the reading, a temperature of the chilled liquid fed to the helical coil or plurality of coils of the cooling/UV disinfection module 60 may be adjusted as needed to achieve the desired temperature of the circulation stream.
C. at least one electroconductivity (EC) sensor 80. An indication of the nutrient level in the circulation stream may be determined by monitoring the electroconductivity (EC) of the water (the equivalent of total dissolved solids or nutrient concentration). The EC may be monitored by at least one EC sensor. In specific embodiments, adjustments to EC may be made by the at least one nutrient feed line 10 and/or eductor injection system 20 to the content of the nutrient(s) in the circulation stream.
D. at least one dissolved oxygen (DO) sensor 85. The dissolved oxygen sensor reads the actual dissolved oxygen in the circulation stream. The dissolved oxygen levels from the nanobubble generator module 55 maybe adjusted as desired.

As noted, the system has a holding tank 25, which houses a desired amount of the nutrient composition/nutrient water for forwarding to a plant growing environment or for recirculation through the system and continued modification or optimization. In a specific embodiment, the nutrient composition is forwarded to a greenhouse or hydroponic system. The nutrient composition may be in the form of nutrient water, which may be pumped out of the holding tank, or in the form of a solid nutrient composition, which may be collected from the holding tank. Alternatively, in embodiments, the holding tank itself may be removed from the system and incorporated as a tank or other apparatus in a growing environment, for example, supplying nutrient water to plants via a drip apparatus in a hydroponic system.

According to a method of the present invention, water via a water supply or inlet 12 enters the system. In specific embodiments, the water may have been subjected to reverse osmosis to minimize amount of minerals or metals that might have an adverse effect on plants. The temperature of the water may be adjusted as desired.

As the water is introduced to the system, a nutrient or nutrient mixture in liquid and/or concentrate form is injected into the water via at least one nutrient feed line 10. The resulting circulation stream may circulate through the system according to one or more of the following embodiments, in any desired order and/or any number of times. In embodiments, the method may be adjusted automatically, for example, for the number of times and/or time the circulation stream is recirculated.

According to at least one embodiment, in combination with or separately from the at least one nutrient feed line 10, the water supply/inlet or circulation stream may be fed through the eductor injector 20 to add a powder comprising at least one dry nutrient to the circulation stream which is then sent to holding tank 25. The nutrient composition in the holding tank may be recirculated through the system or forwarded to a plant growing environment.

According to another embodiment, either separately from or in combination with the eductor injector 20 and holding tank 25, the water supply/inlet or circulation stream may be fed through one or more pH injector pumps 35 and static mixer 40 before being fed to the ultrasonic acoustic cavitation reactor 45. The circulation stream is then fed through the cooling/UV disinfection module 60 and sensor network 65 to holding tank 25. In this embodiment, the nanobubble generator module 55 may be bypassed. The nutrient composition in the holding tank may be recirculated through the system or forwarded to a plant growing environment.

According to another embodiment, either separately from or in combination with the eductor injector 20 and holding tank 25, the water supply/inlet or circulation stream may be fed through one or more pH injector pumps 35 and static mixer 40 before being fed to nanobubble generator module 55, bypassing the ultrasonic acoustic cavitation reactor 45. The circulation stream then flows through the cooling/UV disinfection module 60 and sensor network 65 to holding tank 25. The nutrient composition in the holding tank may be recirculated through the system or forwarded to a plant growing environment.

According to another embodiment, the circulation stream may go through the entire system. Water from the water supply/inlet 12 is introduced and nutrient(s) are added via the at least one nutrient feed line 10. The circulation stream is then fed through the eductor injector 20 to add at least one dry nutrient to the circulation stream, which is then fed to holding tank 25. A circulation stream from the holding tank 25 flows through the nanobubble generator module 55 and is then diverted through the ultrasonic cavitation reactor 45 and through the cooling/UV disinfection module 60 and sensor network 65 back to the holding tank 25. The nutrient composition in the holding tank may be recirculated or returned to the system or forwarded to a plant growing environment.

Alternatively, a circulation stream from the holding tank 25 flows through the ultrasonic cavitation system 45, then through the nanobubble generator module 55 and through the cooling/UV disinfection module 60 and sensor network 65 back to the holding tank 25. The nutrient composition in the holding tank may be recirculated or returned to the system or forwarded to a plant growing environment.

In an embodiment, the circulation stream may circulate or recirculate according to one or more of the above embodiments during customization of a nutrient composition or nutrient water for a particular plant and/or plant growing environment.

According to the present invention, the nutrient composition may be customized for the kind of plants to be grown and/or for the particular kind of growing environment. In a specific embodiment, one or more plants that are fed the nutrient composition may be evaluated on-site. Evaluation may include monitoring and/or analysis of, for example, one or more of the condition or development stage of the plant (e.g., at or near flower); feeding cycle; whether or not the plant needs additional moisture (e.g., a growing environment using soil or rock wool); a need for root stimulation; whether the plant needs one or more additional nutrients (e.g., one or more of nitrogen, copper, zinc, or phosphorous); whether the plant needs more or less oxygen; or the desired nutrient composition temperature. A nutrient deficiency can negatively affect plant growth and yield. In a specific embodiment, plant growth records may be part of the evaluation and analysis. Similarly, a historical level of one or more particular plant chemicals (e.g., terpene, CBD, THC) may be part of any evaluation and analysis.

In particular, for growing cannabis in a hydroponic system, the system and methods of the present invention allow for a nutrient composition or nutrient water to be customized so that at least one of plant growth, plant yield, or a plant chemical may be optimized or increased to achieve a desired level. The at least one plant chemical may include, but is not limited to, at least one terpene (e.g., myrcene, pinene, limonene, terpinolene, caryopyllene, linalool, humulene, ocimene, guaiol, sabinene, pulegone, valencene, bisabolol); cannabidiol (CBD), cannabinol; cannabichromene; or tetrahydrocannabinol (THC).

Based on the evaluation and analysis, a nutrient composition may be adjusted in or near real-time. The result is a precision-controlled nutrient composition that is optimized for nutrient uptake and use. The required raw materials for providing the nutrients to the system may be reduced, which in turn reduces costs and wasted nutrient(s). For example, according to a specific embodiment, the electrical conductivity of a nutrient composition decreased by only about 15 to about 20% after one week of use in a hydroponic growing environment. Water use may also be reduced as nutrient runoff from the growing environment can be recycled through the system via the water supply or inlet and reused. In an embodiment, water from the growing environment is cleaned and/or filtered, for example via electro-oxidation, and then recycled back to the system.

In specific embodiments, a nutrient composition, with or without nanobubbles, may be produced and stored in one or more parts. In a specific embodiment, because some constituents tend to separate if stored, the composition is stored in two separate parts that are later injected into and mixed within the system.

### INDUSTRIAL APPLICABILITY

The present invention is directed to systems and methods for making a nutrient composition or nutrient water. In particular, the system and methods are directed to making a nutrient composition or nutrient water to be used in a growing environment, such as for growing fruits, vegetables, hemp, or cannabis.

Although only certain embodiments of the invention have been illustrated in the foregoing specification, it is understood by those skilled in the art that many modifications and embodiments of the invention will come to mind to which the invention pertains, having benefit of the teaching presented in the foregoing description and associated drawings.

It is therefore understood that the invention is not limited to the specific embodiments disclosed herein, and that many modifications and other embodiments of the invention are intended to be included within the scope of the invention. Moreover, although specific terms are employed herein, they are used only in a generic and descriptive sense, and not for the purposes of limiting the description of the invention.

1. A nutrient system, comprising:
at least one nutrient feed line for introducing at least one nutrient into a water inlet or supply to form a circulation stream;
an eductor injector for introducing a powder comprising at least one dry nutrient into the circulation stream;
an ultrasonic acoustic cavitation reactor for applying at least one frequency to the circulation stream; and
a nanobubble generator module for introducing nanobubbles of at least one gas into the circulation stream.

2. A nutrient system according to claim 1, wherein the ultrasonic acoustic cavitation reactor is a dual frequency ultrasonic cavitation reactor.

3. A nutrient system according to claim 1, further comprising a cooling/ultraviolet disinfection module for cooling and disinfecting the circulation stream.

4. A nutrient system according to claim 3, wherein the cooling/ultraviolet disinfection module comprises:
a helical coil or plurality of coils through which a chilled liquid is circulated;
an inlet for oxygenated water, configured such that said oxygenated water contacts said helical coil or plurality of coils;
a passageway having an electropolished metal surface or mirrored surface through which the oxygenated water is directed;
at least one UV light that provides UV light to the oxygenated water, thereby disinfecting the oxygenated water; and
an outlet for the oxygenated water.

5. A nutrient system according to claim 1, further comprising at least one of:
at least one pH sensor to measure a pH of the circulation stream;
at least one temperature sensor to measure a temperature of the circulation stream;
at least one electroconductivity sensor to measure a nutrient level of the circulation stream; or
at least one dissolved oxygen sensor to measure dissolved oxygen in the circulation stream.

6. A method for obtaining a nutrient composition, comprising:
introducing at least one nutrient into a water supply or inlet to form a circulation stream, wherein the at least one nutrient is in liquid or concentrate form;
introducing a powder comprising at least one dry nutrient into the circulation stream by an eductor injector;
applying at least one frequency to the circulation stream by an ultrasonic acoustic cavitation reactor, thereby reducing a size of one or more nutrients in the circulation stream; and
introducing nanobubbles of at least one gas into the circulation stream by a nanobubble generator module.

7. A method according to claim 6, further comprising:
cooling and disinfecting the circulation stream; and
obtaining a nutrient composition or nutrient water.

8. A method according to claim 6, wherein the at least one gas comprises oxygen and/or nitrogen.

9. A method according to claim 6, wherein the at least one gas comprises ozone.

10. A method according to claim 6, comprising applying dual frequencies to the circulation stream after said introducing nanobubbles of at least one gas into the circulation stream.

11. A method according to claim 6, further comprising adjusting at least one of a pH, nutrient level, temperature, or oxygen level of the circulation stream.

12. A nutrient composition or nutrient water made by the method of claim 6.

13. A method for growing a plant, comprising feeding a nutrient composition or nutrient water according to claim 12.

14. A method for growing a plant, comprising feeding a nutrient composition or nutrient water obtained by the method of claim 6 to a growing environment.

15. A method according to claim 14, wherein the growing environment is a hydroponic environment comprising one or more plants.

16. A method according to claim 14, wherein the one or more plants comprise a fruit or vegetable.

17. A method according to claim 14, wherein the one or more plants comprise cannabis.

18. A method for customizing a nutrient composition or nutrient water for one or more plants to be grown in a growing environment, comprising:
evaluating one or more plants that are fed the nutrient composition or nutrient water obtained according to claim 6; and
adjusting at least one of a pH, nutrient level, temperature, oxygen level, or amount of water of the nutrient composition or nutrient water based on said evaluating.

19. A method according to claim 18, wherein said evaluating comprises analysis of at least one of:
a development stage of the one or more plants;
a time of a water feeding cycle;
a moisture level of the one or more plants;
at least one nutrient level; or
a temperature of the nutrient composition or nutrient water.

20. A method according to claim 18, wherein said evaluating comprises analysis of a growth history of the one or more plants.

21. A method according to claim 18, wherein said evaluating comprises analysis of a historical level of a particular plant chemical of the one or more plants.

22. A method according to claim 21, wherein said one or more plants comprise cannabis and said plant chemical comprises at least one of at least one terpene; cannabidiol; cannabinol; cannabichromene; or tetrahydrocannabinol.

23. A method for growing a plant, comprising:
customizing a nutrient composition or nutrient water obtained by the method of claim 18;
feeding the nutrient composition or nutrient water to one or more plants in a plant growing environment; and
increasing a plant yield or a level of plant chemical of the one or more plants.
